(19) United States
(12) Patent Application Publication
(10) Pub. No.: US 2022/0067341 A1
(43) Pub. Date: Mar. 3, 2022

(54) WRITING PEN, SIGNATURE RECOGNITION METHOD AND SIGNATURE RECOGNITION SYSTEM

(71) Applicant: Waltop International Corporation, Hsinchu City (TW)

(72) Inventor: Min-Chih HSUAN, Hsinchu (TW)

(21) Appl. No.: 17/314,280

(22) Filed: May 7, 2021

(30) Foreign Application Priority Data
Aug. 31, 2020 (TW) 109129798

(51) Int. Cl. G06K 9/00; G06F 3/0354; G06F 3/0346; G06F 3/038; G06K 9/22; G06K 9/24

(52) U.S. Cl. CPC G06K 9/00174; G06F 3/03545; G06F 3/0346; G06F 2203/0384; G06K 9/224; G06K 9/00181; G06K 9/24; G06F 3/038

(57) ABSTRACT

A writing pen, a signature recognition method, and a signature recognition system are provided. A non-writing end of the writing pen is equipped with a motion sensing device. The writing pen records a motion trajectory of the non-writing end when the writing pen writes on a plane writing trajectory generating device. When the motion trajectory and/or a plane writing trajectory pass a comparison, a signature comparison device determines that a signature is from a specific person.

### CROSS-REFERENCE TO RELATED PATENT APPLICATION

This application claims the benefit of priority to Taiwan Patent Application No. 109129798, filed on Aug. 31, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an innovative authentication method and system based on biometrics, and more particularly to a writing pen and a signature recognition method and system for recognizing a signature made by the writing pen.

### BACKGROUND OF THE DISCLOSURE

Signatures have a long history of being used as a method for identity verification. With the rise of electronic transactions, businesses have tried using electronic devices and mobile devices for signature authentication. However, signing on touch panels of the electronic devices and the mobile devices can only provide limited types and numbers of features, which are insufficient for executing a correct identity verification. If an electronic signature is to provide sufficient types and numbers of features, multiple features need to be detected at the same time and a large amount of data needs to be obtained. This identity verification method, however, does not meet the requirements of commercial applications.

To address technological issues that the electronic signature cannot solve, “air signatures” have been developed in the industry. Generally, a signer makes a certain gesture in the air with their body parts, and after a computer vision captures such a movement, features from the signer are extracted to perform an identity verification. This technique is mainly based on the fact that human limbs have multiple joints, and even when the same movements are performed by different people, the outcomes produced thereby will be different.

Conventionally, a motion trajectory of limb movement is used for identification; however, a user will need a large enough space to perform such a process, which causes inconvenience.

### SUMMARY OF THE DISCLOSURE

In response to the above-referenced technical inadequacy, the present disclosure provides a novel signature comparison technique for performing an identity verification. The present disclosure also provides a novel writing pen for performing a signature comparison.

In one aspect, the present disclosure provides a writing pen. The writing pen includes a pen body, an inducer, and an air signature generator. The pen body includes a writing end and a motion sensing end, which are separated by a handheld reference point. The inducer is disposed at the writing end for generating a writing trajectory on a sensing surface. The air signature generator is disposed at the motion sensing end, which includes a motion sensing device, a first communication device, a control device, and a power supply. The motion sensing device is configured to sense a three-dimensional motion of the motion sensing end and continually output at least one one-dimensional reading value of the three-dimensional motion at predetermined time intervals. The first communication device is configured to establish a communication channel with an external device in a wireless or a wired manner. The control device is connected to the motion sensing device and the first communication device, so as to receive a sensing result data of the motion sensing device, and to process and transmit the sensing result data to the external device through the first communication device. The control device is configured to: record a current time as a first time after receiving a start detection command and capture a reading value of the motion sensing device, and record another current time as a second time after receiving a stop detection command to generate an air signature file containing the first time, the reading value of the motion sensing device, and the second time, so as to activate the first communication device to transmit the air signature file to the external device. The power supply is connected to the motion sensing device, the first communication device, and the control device, so as to provide power to the motion sensing device, the first communication device, and the control device.

In another aspect, the present disclosure provides a signature recognition method and system. The signature recognition system provided by the present disclosure includes at least one writing pen with the abovementioned features and a signature recognition device. The signature recognition device includes a signature data storage, a second communication device, and a signature comparison device. The signature data storage device is configured to store a plurality of reference air signature files, and each of the reference air signature files corresponds to a signature account. The second communication device is configured to establish the communication channel with the first communication device of the writing pen to exchange data with the writing pen. The signature comparison device is configured to perform a feature comparison between the air signature file received from the writing pen and at least one of the reference air signature files in the signature data storage device. The signature comparison device determines that the air signature file and the at least one of the reference air signature files are from a same provider, when an approximate value of a feature comparison result is higher than a specific critical value, and a difference value between a first and a second time and a comparison time is less than a specific value.

The signature recognition method provided by the present disclosure includes steps described below. A writing pen is activated. The writing pen includes a pen body, an inducer, and an air signature generator. The pen body includes a writing end and a motion sensing end, which are separated by an angle of at least 90 degrees. The inducer is disposed at the writing end. The air signature generator is disposed at the motion sensing end, and the air signature generator includes a motion sensing device, a first communication device, and a control device. The motion sensing device is configured to sense a three-dimensional motion of the motion sensing end and continually output at least one one-dimensional reading value of the three-dimensional motion at predetermined time intervals. The first communication device is configured to establish a communication channel with an external device in a wireless or a wired manner. The control device is configured to record a first time of a starting operation and capture a reading value of the motion sensing device, and to record a second time of a stopping operation, so as to generate an air signature file containing the first time, the reading value of the motion sensing device, and the second time. The air signature file is recorded. A feature comparison between the air signature file and one of a plurality of reference air signature files in a signature data storage device storing a plurality of reference signature files is performed. Then, the air signature file and the reference air signature file are determined to be from the same provider via a signature comparison device when an approximate value of a feature comparison result is higher than a specific critical value, and a difference value between the first time, the second time or a combination thereof and a comparison time is less than a specific value.

In some exemplary embodiments, the signature recognition method includes steps as follows: activating a writing pen to receive an air signature file sent by the writing pen; activating a writing trajectory generating device to capture a motion trajectory of the writing pen, so as to generate a plane signature file describing the motion trajectory, in which the plane signature file includes a start time data and an end time data of the motion trajectory; performing a feature comparison between the air signature file received from the writing pen and at least one reference air signature file in a signature data storage device storing a plurality of reference signature files, and performing a feature comparison between the plane signature file received from the writing trajectory and at least one reference plane signature file in the signature data storage; determining that the air signature file and the at least one reference air signature file are from the same provider via a signature comparison device when an approximate value of a feature comparison result between the air signature file and the at least one reference air signature file is higher than a first critical value, and an approximate value of a feature comparison result between the plane signature file and the reference plane signature file is higher than a second critical value; and outputting a determination result.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a signature recognition system in a use state according to an embodiment of the present disclosure;

FIG. 2 is a schematic structural view of a writing pen according to an embodiment of the present disclosure;

FIG. 3 is a block diagram of the signature recognition system according to an embodiment of the present disclosure;

FIG. 4 is a flowchart of a signature recognition method according to an embodiment of the present disclosure; and

FIG. 5 is a flowchart of the signature recognition method according to another embodiment of the present disclosure.

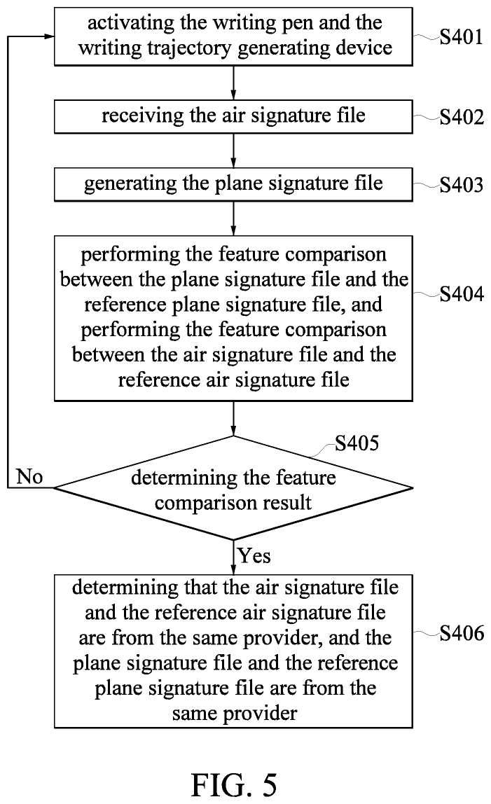

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a signature recognition system and method based on air signature recognition technology. Although the present disclosure is not restricted by any technical principles or concepts, it has been noticed that while past technology on air signature recognition has developed to an extent sufficient for application, only motion trajectories made by free ends of human limbs are used as signatures. As a result, the air signature recognition technology is unable to be used in everyday life due to an air signature requiring large enough room.

According to the design of the present disclosure, the air signature refers to a motion trajectory of a non-writing end of a writing pen in a three-dimensional space. Since the non-writing end is usually farther away from a motion axis of the writing pen than a writing end, when the writing pen is used for writing, the motion trajectory of the non-writing end can be appropriately enlarged, which is beneficial for the air signature. Such an air signature can be used as a biometric feature and become a basis for identifying a same signer.

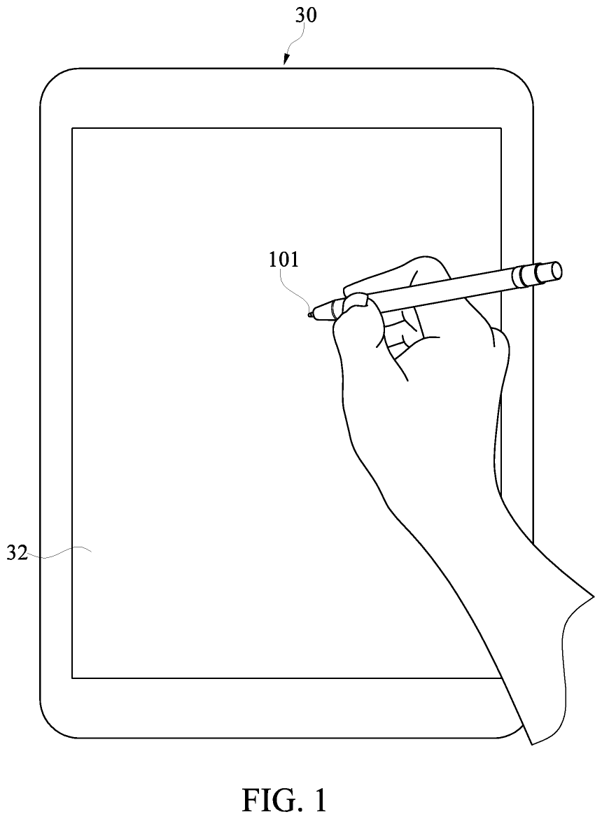

Reference is made to FIG. 1 to FIG. 3, which are respectively a schematic view of a signature recognition system in a use state, a schematic structural view of a writing pen, and a block diagram of the signature recognition system according to an embodiment of the present disclosure. As shown in the figures, the signature recognition system of the present disclosure is based on an air signature recognition, which mainly includes a writing pen 10 and a signature recognition device 20. The writing pen 10 can be a signature pen, but is not limited thereto. The signature recognition system usually includes a writing trajectory generating device 30, which can be a touch screen. However, the writing trajectory generating device 30 can also be any device that can record a motion trajectory of a writing end 101 of the writing pen 10 on a surface of the writing trajectory generating device 30 when the writing end 101 of the writing pen 10 contacts or approaches the writing trajectory generating device 30, such as a capacitive signature pad or signature pads of other types. In an exemplary embodiment of the present disclosure, the writing pen 10 has a wireless communication capability and can establish a wireless communication channel with the signature recognition device 20 to exchange data. The writing trajectory generating device 30 is usually connected to the signature recognition device 20 in a wired manner, so as to transmit the motion trajectory data of the writing end 101 recorded by the writing trajectory generating device 30 to the signature recognition device 20. In some embodiments of the present disclosure, the signature recognition device 20 is implemented in a computer apparatus (such as a desktop computer, a notebook computer, a tablet computer, a smart phone, etc.), and the writing trajectory generating device 30 (e.g., being a touch screen) is a touch screen of the computer apparatus. Naturally, other types of apparatus, devices, and communication methods can also be applied in the present disclosure.

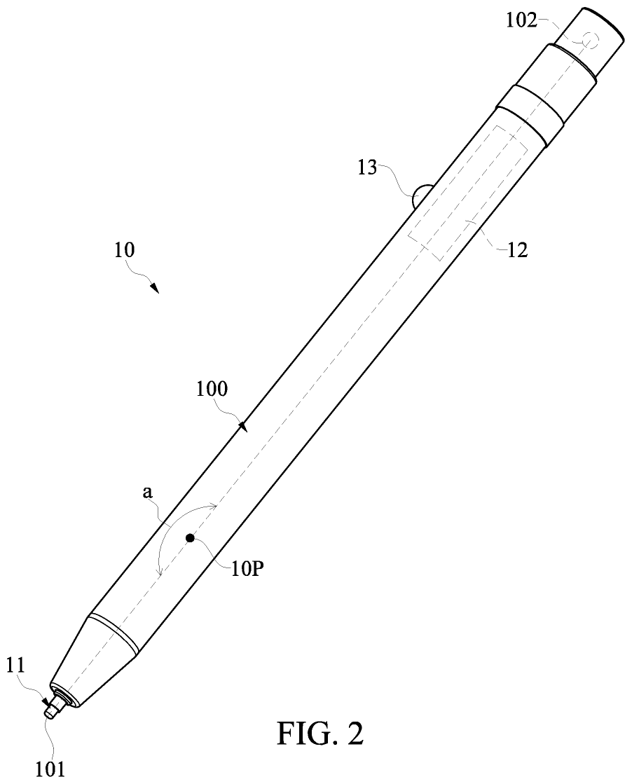

As shown in FIG. 2, the writing pen 10 provided by the present disclosure can be in a shape of a long rod, so as to facilitate handheld use, but is not limited thereto. According to the embodiment of the present disclosure, the greater a ratio of a distance from the non-writing end to a handheld reference point to a distance from the writing end to the handheld reference point is, the better a recognition effect is. Therefore, a shape of the writing pen 10 mainly includes a rod-shaped pen body 100 (that is, an elongated pen body), and a handheld segment is provided. The handheld segment includes a handheld reference point 10P. When the pen body 100 is held by a hand for signing purposes, the handheld reference point 10P refers to a center point surrounded by the pen body 100 that is in motion.

Furthermore, the writing pen 10 further includes a writing end 101 and a motion sensing end 102 that is opposite to the writing end 101 relative to the handheld reference point 10P. As previously mentioned, a distance from the motion sensing end 102 to the handheld reference point 10P should be greater than a distance from the writing end 101 to the handheld reference point 10P, and a ratio thereof is preferably between 2 to 10 times, more preferably 2 to 5 times, and most preferably 2.5 times. In addition, in order to enlarge a magnification of the motion trajectory of the motion sensing end 102, a line segment defined from the writing end 101 to the handheld reference point 10P and a line segment defined from the motion sensing end 102 to the handheld reference point 10P form an angle a of at least 90 degrees. The angle a is preferably between 120 degrees and 180 degrees, and more preferably between 170 degrees and 180 degrees. In general, the angle a is 180 degrees so as to facilitate the manufacturing of the writing pen 10, but this angle is not to be construed as a technical limitation on the present disclosure.

An inducer 11 is disposed at the writing end 101 for generating a writing trajectory on a sensing surface 32 of the writing trajectory generating device 30. The sensing surface 32 is usually disposed on a sensing surface of an electronic device (not shown in the figures), such as a computer device, a tablet device, a mobile device, a credit card machine, and the like. In a common application of the present disclosure, the sensing surface 32 is configured on a capacitive electronic device to provide a plane surface, and a plurality of sensing units are arranged below the plane surface. The sensing units are usually capacitive units, and when the inducer 11 passes through the sensing units, the sensing units are triggered to change their state, such as changing a capacitance value. The distribution of a state change on the plane surface renders a trajectory of the inducer 11 moving on the plane surface. A material of the inducer 11 can be a material of capacitive stylus pen heads in the market, such as conductive materials (which include conductive cotton, rubber coated with conductive paint, conductive silicone, conductive fibers, etc.), and there are no restrictions for the shape of the inducer.

FIG. 2 shows that the writing pen 10 can also have an air signature generator 12 according to an embodiment of the present disclosure, and the air signature generator 12 is disposed at the motion sensing end 102. A structure of the air signature generator 12 mainly includes a motion sensing device 121, a first communication device 122, a control device 123, and a power supply 124.

The motion sensing device 121 is configured to sense a three-dimensional motion of the motion sensing end 102 and continually output at least one one-dimensional reading value of the three-dimensional motion at predetermined time intervals. For example, the motion sensing device 121 can output a reading value every three seconds within a minute, but is not limited thereto. The motion sensing device 121 is a motion sensing device suitable for use in the writing pen 10 of the present disclosure, and includes various commercially available inertial sensors, such as accelerometers, gyroscopes, and magnetometers. This type of motion sensing device is usually made into a chip and provides a single-axis, two-axis, three-axis, six-axis or nine-axis sensing capabilities. Therefore, the reading value can also be a two-dimensional reading value or a three-dimensional reading value.

The first communication device 122 is configured to establish a communication channel with an external device in a wireless or wired manner. The first communication device 122 is a communication device applied to the writing pen of the present disclosure, and includes various commercially available communication circuit chips or modules. The wired communication channel can be USB channels, Type C channels, etc. The wireless communication channel can be BLUETOOTH® and IEEE. The related techniques and applications are already well known in the industry.

The control device 123 is connected to the motion sensing device 121 and the first communication device 122. The control device 123 is configured to receive a sensing result data of the motion sensing device 121, and to process and transmit the sensing result data to the external device through the first communication device 122. In an exemplary embodiment of the present disclosure, the control device 123 is configured to: record a current time (that is, the time at the present moment) as a first time after receiving a start detection command and capture a reading value of the motion sensing device 121, and record another current time (the time at the present moment) as a second time to generate an air signature file containing the first time, the reading value of the motion sensing device 121, and the second time, so as to activate the first communication device 122 to transmit data (that is, the air signature file) to the outside (for example, the external device, but is not limited thereto). The control device 123 can be a circuit module or other commercially available controller products, and is already a mature product on the market. For example, the chip used by the abovementioned motion sensing device 121 usually includes one suitable control device 123, which can provide the abovementioned and other motion sensing-related functions.

The power supply 124 is connected to the motion sensing device 121, the first communication device 122, and the control device 123 to provide power to the motion sensing device 121, the first communication device 122, and the control device 123. Power supply modules (such as dry cells or lithium batteries, but not limited thereto) used in various electronic components can be applied to the present disclosure. The power supply 124 can also provide a power cord (not shown in the figures) for plugging in a power plug.

The pen body 100 of the writing pen 10 can also include a switch 13 to generate at least one of the start detection command or the stop detection command. In an exemplary embodiment of the present disclosure, the switch 13 can be a push button switch, an electrostatic switch, or a pressure sensing switch, etc.; however, the pressure sensing switch is more suitable.

In some embodiments of the present disclosure, the control device 123 can include an air trajectory description device 1230 that is configured to generate a corresponding air trajectory description data according to the reading value of the motion sensing device 121, and to describe a motion trajectory of the motion sensing end 102 between the first time and the second time. Similar to what is mentioned above, the motion trajectory can be a one-dimensional motion trajectory, a two-dimensional motion trajectory or a three-dimensional motion trajectory. For example, the air trajectory description device 1230 can generate a two-dimensional motion trajectory description data according to a set of three-dimensional motion trajectory sensing data. In this embodiment, the air signature file transmitted by the control device 123 to the external device through the first communication device 122 includes the trajectory description data.

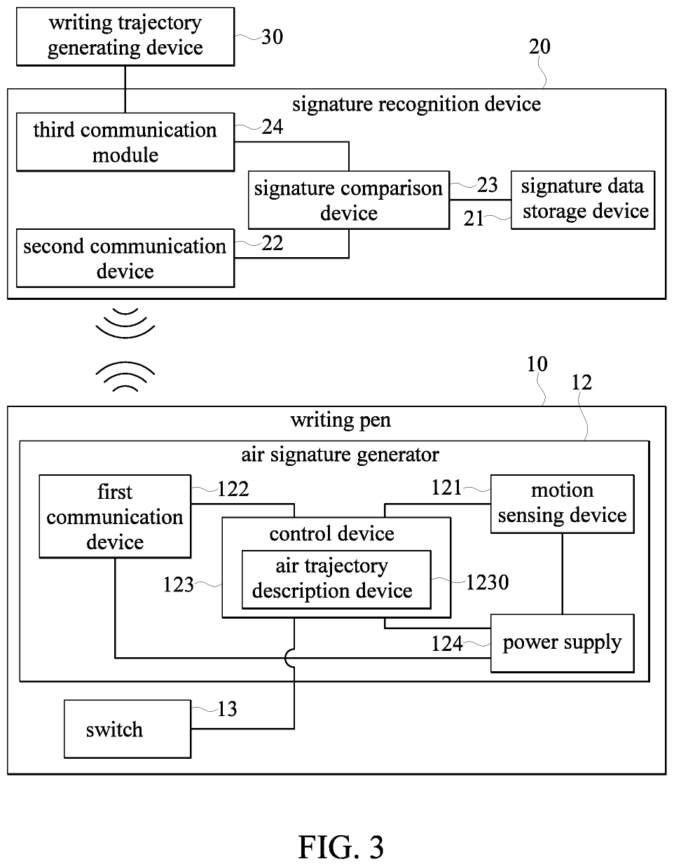

Reference is made to FIG. 3, in which the signature recognition device 20 is illustrated. As shown in FIG. 3, the signature recognition device 20 mainly includes a signature data storage device 21, a second communication device 22, and a signature comparison device 23. The signature recognition device 20 can be various commercially available credit card machines, but is not limited thereto.

The signature data storage device 21 is configured to store a plurality of reference air signature files, and each of the reference air signature files corresponds to a signature account.

The second communication device 22 is configured to establish the communication channel with the first communication device 122 of the writing pen 10 to exchange data with the writing pen 10.

The signature comparison device 23 is configured to perform a feature comparison between the air signature file received from the writing pen 10 and at least one of the reference air signature files in the signature data storage device 21. When an approximate value of a feature comparison result is higher than a specific critical value, the signature comparison device 23 determines that the two air signature files are from the same provider. In an exemplary embodiment of the present disclosure, the signature comparison device 23 is configured to determine that the two air signature files are from the same provider, only if a difference value between the first time, the second time or a combination thereof and a comparison time is less than a specific value.

According to the present disclosure, the signature comparison device 23 has the ability to compare air signatures. A so-called air signature comparison can include comparing a three-dimensional trajectory describing a motion of the motion sensing end 102 of the writing pen 10 in the air with another three-dimensional trajectory (that is, the reference air signature file) describing the motion of the motion sensing end 102 of the writing pen 10 in the air, and determining if the signatures are from the same signer according to whether a similarity of the two three-dimensional trajectories is higher than a specific critical value. For example, when the similarity of the two three-dimensional trajectories is 90%, which is higher than the specific critical value (85%), the signature comparison device 23 determines that the two three-dimensional trajectories are from the same signer. However, one plane trajectory formed by a motion trajectory of the motion sensing end 102 of the writing pen 10 in the air that is projected on a specific plane surface can be compared with another plane trajectory (i.e., reference plane signature file that will be described later) formed by a motion trajectory of the motion sensing end 102 of the writing pen 10 in the air that is projected on the specific plane surface, so as to determine if the signatures are from the same signer. A determination method of the plane trajectory can be the same as that of the three-dimensional trajectories described previously.

In terms of comparing the three-dimensional trajectories, a dynamic time warping method is currently available for application. A two-dimensional trajectory comparison method is a fairly mature technique, and converting a trajectory in the three-dimensional space into a projected plane trajectory on a specific plane is also a common technique. It has been noticed that the two-dimensional trajectory comparison method can already provide a correct determination. At least in an embodiment described below, a plane signature comparison step is also provided to improve the comparison effect of the air signature.

In order to provide a plane signature comparison function, in some exemplary embodiments of the present disclosure, the signature data storage device 21 additionally stores a plurality of reference plane signature files, and each of the reference plane signature files corresponds to one reference air signature file and one signature account. In this embodiment, the second communication device 22 is also configured to establish a communication channel with the writing trajectory generating device 30 to exchange data. Alternatively, a third communication module 24 is also provided in the signature recognition device 20 to establish a communication channel with the writing trajectory generating device 30. As previously mentioned, the writing trajectory generating device 30 provides the sensing surface 32 to interact with the inducer 11 and record a motion trajectory of the inducer 11 on the sensing surface, so as to generate a plane signature file describing the motion trajectory. In practical application, the plane signature file includes a start time data and an end time data of the motion trajectory.

According to the design of the present disclosure, in an exemplary embodiment of the present disclosure, steps for the signature comparison device 23 to compare signatures include:

performing a feature comparison between the air signature file received from the writing pen and the at least one of the reference air signature files in the signature data storage device; and determining that the air signature file and the at least one of the reference air signature files are from the same provider, when an approximate value of a feature comparison result is higher than a specific critical value, and a difference value between the first time, the second time or a combination thereof, and the start time, the end time or a combination thereof is less than a specific value. For example, the signature data storage device 21 or the signature comparison device 23 can pre-store data regarding the start time and the end time. When a time difference between the first time and the second time is 20 seconds, a time difference between the start time and the end time is 25 seconds, and a difference value between 20 seconds and 25 seconds is less than the specific value (for example, 6 seconds), the feature comparison result is used in cooperation with the signature comparison device 23 to determine whether or not the two air signature files are from the same provider, but a method for comparing time is not limited thereto.

In other exemplary embodiments of the present disclosure, the steps for the signature comparison device 23 to compare signatures include:

performing a feature comparison between the air signature file received from the writing pen and at least one of the reference air signature files in the signature data storage device, and performing a feature comparison between the plane signature file received from the writing trajectory generating device and at least one of the reference plane signature files in the signature data storage device; and

determining that the two air signature files are from the same provider when an approximate value of a feature comparison result between the air signature file and the reference air signature file is higher than a first critical value (the comparison method refers to the abovementioned content, and the first critical value can be defined as 85%, but is not limited thereto), and an approximate value of a feature comparison result between the plane signature file and the reference plane signature file is higher than a second critical value (the comparison method refers to the abovementioned content, and the second critical value can be defined as 90%, but is not limited thereto).

In addition, in other exemplary embodiments of the present disclosure, the steps for the signature comparing device 23 to compare signatures include:

performing a feature comparison between the air signature file received from the writing pen and the at least one of the reference air signature files in the signature data storage device, and performing a feature comparison between the plane signature file received from the writing trajectory generating device and the at least one of the reference plane signature files in the signature data storage device; and

determining the two air signature files are from the same provider when the approximate value of the feature comparison result between the air signature file and the reference air signature file is higher than the first critical value, and the approximate value of the feature comparison result between the plane signature file and the reference plane signature file is higher than the second critical value, and a difference value between the first time, the second time or a combination thereof and the start time, the end time or a combination thereof is less than a specific value.

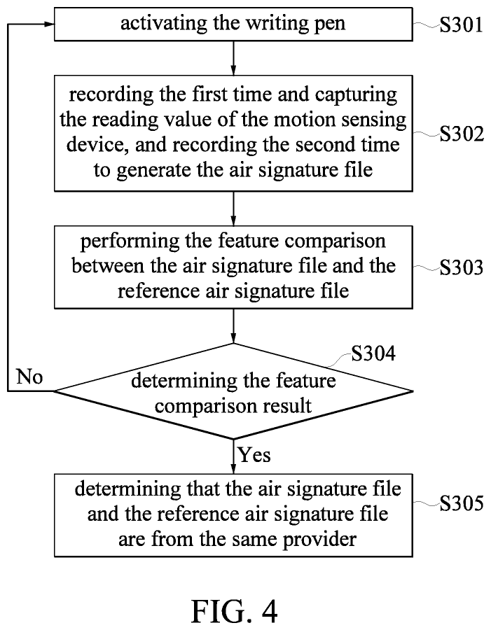

Several exemplary embodiments of the signature recognition method of the present disclosure will be described below. FIG. 4 is a flowchart of a signature recognition method according to an embodiment of the present disclosure. As shown in the figure, the signature recognition method provided by the present disclosure includes the following steps:

First, in step S301, the writing pen 10 is activated. The writing pen 10 can be one of the abovementioned writing pens. Next, in step S302, the control device is configured to record a first time of a starting operation and capture a reading value of the motion sensing device 121, and to record a second time of a stopping operation, so as to generate the air signature file containing the first time, the reading value of the motion sensing device 121, and the second time. Further, in step S303, a feature comparison is performed between the air signature file and a specific reference air signature file in the signature data storage device 21 storing a plurality of reference signature files. The specific reference air signature file can be recorded according to a serial number, a name, and other data input by a user when the writing pen 10 starts to record an air signature trajectory. In this way, no comparison is needed for all the signature files in the signature data storage device 21. In step S304, when an approximate value of a feature comparison result is higher than a specific critical value, and a difference value between the first time and the second time with a comparison time is less than a specific value, the method then proceeds to step S305, where the signature comparison device determines that the two air signature files (that is, the air signature file and the reference air signature file) are from the same provider. If the feature comparison result does not meet the above conditions, the signature comparison device then determines that the two air signature files are from different providers, and step S301 is executed again. Or, the writing pen 10 can issue a warning signal and not operate.

As previously mentioned, the signature recognition method of the present disclosure can additionally include a step of generating motion trajectory data describing a motion trajectory of the motion sensing device 121 according to the reading value of the motion sensing device 121 via the control device of the writing pen, and including the motion trajectory data in the air signature file. The motion trajectory can be one-dimensional, two-dimensional, or three-dimensional.

In some exemplary embodiments of the present disclosure, the signature recognition method can further include a comparison of plane signature trajectories. The recognition method of this embodiment is shown in the flowchart of FIG. 4. The signature recognition method of the present disclosure can include the following steps:

First, in step S401, the writing pen 10 and the writing trajectory generating device 30 are activated at the same time. Next, in step S402, the air signature file sent by the writing pen 10 is received. Later, in step S403, the writing trajectory generating device 30 captures a motion trajectory of the writing pen 10, so as to generate a plane signature file describing the motion trajectory. The air signature file and the plane signature file both include a start time data and an end time data of the motion trajectory (captured data).

Then, in step S404, a feature comparison between the plane signature file sent by the writing trajectory generating device 30 and the reference plane signature file stored in the signature data storage device 21 storing the plurality of reference signature files is performed, and a feature comparison between the air signature file received from the writing pen 10 and at least one of the reference air signature files in the signature data storage device 21 is performed. In step S405, when an approximate value of the two feature comparison results is higher than a specific critical value, and a difference value between the first time, the second time or a combination thereof, and the start time, the end time or a combination thereof is less than a specific value, the method then proceeds to step S406, where the signature comparison device determines that the two air signature files and the two plane signature files are from the same provider. That is, the plane signature file and the reference plane signature file are from the same provider, and the air signature file and the reference air signature file are from the same provider. If the two feature comparison results do not meet the abovementioned conditions, the two air signature files and the two plane signature files are then determined to be from different providers, and step S401 is executed again. Or, at least one of the writing pen 10, the signature recognition device 20, and the writing trajectory generating device 30 can issue a warning signal and not operate.

In other embodiments of the present disclosure, step 404 can also be implemented as:

performing the feature comparison between the air signature file received from the writing pen 10 and the at least one of the reference air signature files in the signature data storage device 21, and performing the feature comparison between the plane signature file received from the writing trajectory generating device 30 and the at least one of the reference plane signature files in the signature data storage device 21; and

determining the two air signature files are from the same provider via the signature comparison device, when the approximate value of the feature comparison result between the air signature file and the reference air signature file is higher than the first critical value, and the approximate value of the feature comparison result between the plane signature file and the reference plane signature file is higher than the second critical value.

The above signature recognition method can be applied to various types of controls, which include, for example, requesting an approval of an operation (especially for operations related to electronic devices, e-commerce, and data applications). In this type of operation, a system, especially a cloud system, receives an operation request and activates the writing pen to perform a signature recognition. When the recognition is successful, the writing pen will operate according to the request; when the recognition is unsuccessful, a warning signal will be issued and no operation will be performed.

As mentioned above, the present disclosure provides a novel signature comparison mechanism. The present disclosure provides the writing pen, and the non-writing end of the writing pen is equipped with the motion sensing device. When the user uses the writing pen to write on a plane writing trajectory generating device, in addition to a plane writing trajectory, a motion trajectory of the non-writing end (that is, the motion sensing end 102) is also recorded. During comparison, the plane signature, the air signature or a combination thereof can be determined to be from a specific user when the motion trajectory passes the comparison, the plane writing trajectory passes the comparison, the motion trajectory and the plane writing trajectory pass the comparison, or any one of the aforementioned three types and a time difference calculation result are correct. Under the design of the present disclosure, not only can an accuracy of the signature authentication be improved, but a technical threshold of the air signature can also be lowered.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A writing pen, comprising:
a pen body including a writing end and a motion sensing end, the writing end and the motion sensing end being separated by a handheld reference point;
an inducer disposed at the writing end for generating a writing trajectory on a sensing surface; and
an air signature generator disposed at the motion sensing end, the air signature generator including:
a motion sensing device configured to sense a three-dimensional motion of the motion sensing end and continually output at least one one-dimensional reading value of the three-dimensional motion at predetermined time intervals;
a first communication device configured to establish a communication channel with an external device in a wireless or a wired manner;
a control device connected to the motion sensing device and the first communication device, so as to receive a sensing result data of the motion sensing device, and to process and transmit the sensing result data to the external device through the first communication device; and
a power supply connected to the motion sensing device, the first communication device, and the control device, so as to provide power to the motion sensing device, the first communication device, and the control device;
wherein the control device is configured to: record a current time as a first time after receiving a start detection command and capture a reading value of the motion sensing device, and record another current time as a second time after receiving a stop detection command to generate an air signature file containing the first time, the reading value of the motion sensing device, and the second time, so as to activate the first communication device to transmit the air signature file to the external device;
wherein the control device includes an air trajectory description device that is configured to generate a corresponding air trajectory description data according to the reading value of the motion sensing device, and to describe a motion trajectory of the motion sensing end between the first time and the second time;
wherein the motion trajectory is a one-dimensional motion trajectory, a two-dimensional motion trajectory or a three-dimensional motion trajectory, and the air signature file transmitted by the control device to the external device through the first communication device includes the air trajectory description data.

2. The writing pen according to claim 1, wherein a line segment from the writing end to the handheld reference point and a line segment from the motion sensing end to the handheld reference point form an angle of at least 90 degrees or within a range from 160 degrees to 180 degrees.

3. The writing pen according to claim 1, wherein a distance from the motion sensing end to the handheld reference point is greater than a distance from the writing end to the handheld reference point; wherein the distance from the motion sensing end to the handheld reference point is 2 to 10 times the distance from the writing end to the handheld reference point.

4. The writing pen according to claim 1, wherein the pen body of the writing pen further includes a switch for generating at least one of the start detection command and the stop detection command; wherein the switch is a pressure sensing switch.

5. A signature recognition system, comprising:
at least one of the writing pen as claimed in any one of claims 1 to 4; and
a signature recognition device including:
a signature data storage device configured to store a plurality of reference air signature files, each of the reference air signature files corresponding to a signature account;
a second communication device configured to establish a communication channel with the first communication device of the writing pen to exchange data with the writing pen; and
a signature comparison device configured to perform a feature comparison between the air signature file received from the writing pen and at least one of the reference air signature files in the signature data storage device, wherein, when an approximate value of a feature comparison result is higher than a specific critical value, and a difference value between a first time, a second time or a combination thereof and a comparison time is less than a specific value, the signature comparison device determines that the air signature file and the at least one of the reference air signature files are from a same provider.

6. The signature recognition system according to claim 5, wherein the signature data storage device additionally stores a plurality of reference plane signature files, and each of the reference plane signature files corresponds to one of the reference air signature files and the signature account; wherein the second communication device is configured to establish the communication channel with a writing trajectory generating device to exchange data; wherein the writing trajectory generating device provides the sensing surface to interact with the inducer and records a motion trajectory of the inducer on the sensing surface, so as to generate a plane signature file describing the motion trajectory; wherein the plane signature file includes a start time data and an end time data of the motion trajectory;
wherein the signature comparison device is configured to: perform the feature comparison between the air signature file received from the writing pen and the at least one of the reference air signature files in the signature data storage device, and perform a feature comparison between the plane signature file received from the writing trajectory generating device and at least one of the reference plane signature files in the signature data storage device; wherein, when an approximate value of a feature comparison result between the air signature file and the reference air signature file is higher than a first critical value, and an approximate value of a feature comparison result between the plane signature file and the reference plane signature file is higher than a second critical value, the signature comparison device determines that the air signature file and the at least one of the reference air signature files are from the same provider.

7. The signature recognition system according to claim 6, wherein the signature comparison device is configured so that when the approximate value of the feature comparison result between the air signature file and the reference air signature file is higher than the first critical value, the approximate value of the feature comparison result between the plane signature file and the reference plane signature file is higher than the second critical value, and a difference value between the first time, the second time or a combination thereof, and a start time, an end time or a combination thereof is less than a specific value, the signature comparison device determines that the air signature file and the at least one of the reference air signature files are from the same provider.

8. A signature recognition method, comprising steps of:
activating a writing pen, the writing pen including:
a pen body including a writing end and a motion sensing end, the writing end and the motion sensing end being separated by an angle of at least 90 degrees;
an inducer disposed at the writing end; and
an air signature generator disposed at the motion sensing end, the air signature generator including:
a motion sensing device for sensing a three-dimensional motion of the motion sensing end and continually outputting at least one one-dimensional reading value of the three-dimensional motion at predetermined time intervals;
a first communication device for establishing a communication channel with an external device in a wireless or a wired manner; and
a control device for recording a first time of a starting operation and capturing a reading value of the motion sensing device, and for recording a second time of a stopping operation, so as to generate an air signature file containing the first time, the reading value of the motion sensing device, and the second time;
recording the air signature file;
performing a feature comparison between the air signature file and one of a plurality of reference air signature files in a signature data storage device storing a plurality of reference signature files;
determining, via a signature comparison device, that the air signature file and the reference air signature file are from a same provider in response to an approximate value of a feature comparison result being higher than a specific critical value, and a difference value between the first and second times and a comparison time being less than a specific value; otherwise, determining that the air signature file and the reference air signature file are not from the same provider; and
outputting a determination result.

9. The signature recognition method according to claim 8, wherein, after the writing pen is activated, the signature recognition method further includes a step of generating motion trajectory data describing a motion trajectory of the motion sensing device according to the reading value of the motion sensing device via the control device of the writing pen, and including the motion trajectory data in the air signature file; wherein the motion trajectory is two-dimensional or three-dimensional; wherein the reference air signature file is a two-dimensional trajectory description file, and a feature comparison step of the air signature file includes a step of converting an air signature trajectory of the air signature file into a projection description file of the air signature trajectory on a plane.

10. A signature recognition method, comprising steps of:
activating a writing pen to receive an air signature file sent by the writing pen, wherein the writing pen includes:
a pen body including a writing end and a motion sensing end, the writing end and the motion sensing end being separated by an angle of at least 90 degrees;
an inducer disposed at the writing end; and
an air signature generator disposed at the motion sensing end, the air signature generator including:
a motion sensing device for sensing a three-dimensional motion of the motion sensing end and continually outputting at least one one-dimensional reading value of the three-dimensional motion at predetermined time intervals;
a first communication device for establishing a communication channel with an external device in a wireless or a wired manner; and
a control device for recording a first time of a starting operation and capturing a reading value of the motion sensing device, and for recording a second time of a stopping operation, so as to generate the air signature file containing the first time, the reading value of the motion sensing device, and the second time;
activating a writing trajectory generating device to capture a motion trajectory of the writing pen, so as to generate a plane signature file describing the motion trajectory; wherein the plane signature file includes a start time data and an end time data of the motion trajectory;
performing a feature comparison between the air signature file received from the writing pen and at least one reference air signature file in a signature data storage device, and performing a feature comparison between the plane signature file received from the writing trajectory generating device and at least one reference plane signature file in the signature data storage device;
determining, via a signature comparison device, that the air signature file and the at least one reference air signature file are from a same provider in response to an approximate value of a feature comparison result between the air signature file and the at least one reference air signature file being higher than a first critical value, and an approximate value of a feature comparison result between the plane signature file and the at least one reference plane signature file being higher than a second critical value; and
outputting a determination result.

11. The signature recognition method according to claim 10, wherein the step of determining that the air signature file and the at least one reference air signature file are from the same provider via the signature comparison device further includes: determining that the air signature file and the at least one reference air signature file are from the same provider in response to the approximate value of the feature comparison result between the air signature file and the at least one reference air signature file being higher than the first critical value, the approximate value of the feature comparison result between the plane signature file and the at least one reference plane signature file being higher than the second critical value, and a difference value between a first time, a second time or a combination thereof, and a start time, an end time or a combination thereof being less than a specific value.

12. The signature recognition method according to claim 10, wherein, after the writing pen is activated, the signature recognition method further includes a step of generating motion trajectory data describing a motion trajectory of the motion sensing device according to the reading value of the motion sensing device via the control device of the writing pen, and including the motion trajectory data in the air signature file; wherein the motion trajectory is two-dimensional or three-dimensional; wherein the reference air signature file is a two-dimensional trajectory description file, and a feature comparison step of the air signature file includes a step of converting an air signature trajectory of the air signature file into a projection description file of the air signature trajectory on a plane.

13. The signature recognition method according to claim 12, wherein the motion trajectory is the two-dimensional trajectory description file formed by converting the air signature trajectory into the projection description file of the air signature trajectory on the plane.
